(19) United States
(12) Patent Application Publication
(10) Pub. No.: US 2008/0052216 A1
(43) Pub. Date: Feb. 28, 2008

(54) System and method for determining used vehicle market values for use in hedging risks associated with used vehicle futures contracts

(76) Inventors: Arthur W. Johnson, Brooklyn Park, MN (US); Christopher O. Darkins, Houston, TX (US)

Correspondence Address: ARTHUR W. JOHNSON, 8800 TELFORD CROSSING N., BROOKLYN PARK, MN, 55443, US

(21) Appl. No.: 11/507,858

(22) Filed: Aug. 22, 2006

(51) Int. Cl. G06Q 40/00

(52) U.S. Cl. 705/37

(57) ABSTRACT

A method and system of generating a market settlement value for use with settlement of vehicle futures contracts traded on a commodities exchange. The system comprises a data repository that stores vehicle data files, a history filter operatively connected to the data repository and configured to filter select vehicle data files retrieved. The system further includes a matching engine operatively connected to the history filter for grouping files retrieved that have a common digit pattern within a manufacturer VIN code and a pricing engine operatively connected to the matching engine for accessing and processing transaction prices for a select group of vehicles to determine the market settlement value an identified vehicle. The market settlement value is used as an index price to assess gains and losses associated with vehicle futures contracts.

### BACKGROUND OF THE INVENTION

A futures contract is a firm agreement to deliver a certain volume of a commodity at a specified date or dates in the future, which can be bought and sold on an exchange. The futures contract emerged originally to address the risk management needs in the agricultural sector. Grain farmers were often devastated when grain prices at harvest fell below levels that existed at the time of planting. A mechanism was needed that allowed the farmers to pre-sell a crop with price certainty in an open an organized public marketplace. The futures exchanges provided this price management tool with futures contracts in various agricultural products. The success of futures as a hedging tool led to futures contracts in metals, soft commodities, financial products, equity indexes, energy products, and now automobiles.

The automobile is almost unique among consumer durables in having a 10-year+ lifecycle that typically involves several successive changes of ownership. And because it is the second most expensive asset after real estate, the automobile's lifetime value chain generates successive profit opportunities—which, traditionally, carmakers and leasing companies have surrendered to others. In addition, the expense of automobiles has caused consumers to seek new methods of financing, such as leasing. Unlike traditional financing, where the consumer is the owner of the vehicle financed, when a vehicle is leased, the vehicle is the property of the finance company who then assumes the risk of fluctuations in used car prices. Accordingly, vehicle lease finance institutions have large risks relating to the market value of leased vehicles when they are returned at the end of leases.

Finance companies also have risk related to finance vehicles in the event of repossession. One example would be where a finance company repossesses 40,000 vehicles per year, anticipating a one percent repossession rate. In this example, the finance company is experiencing a problem where they are seeing a significant drop in prices on SUV's due to increased gasoline prices. Futures would provide the finance company with the ability to buy a contract on at risk vehicles when an individual falls behind on their payment. It the repossession occurs, the finance company typically has to hold vehicles for 30 to 90 days in view of customer redemption laws and the re-issuance of clean title in the banks name prior to the vehicle being resold. This prolonged hold time makes the bank subject to short term pricing volatility. A bank could purchase a futures contract based on it estimated or actual repossession rate by taking into account the makeup of its most risky borrowers along with their portfolio makeup.

The market value of leased vehicles at the end of a lease (residual value) is very important when lease terms are being set. The residual value determines how aggressive the leasing company can be when defining lease terms. If the residual value is set at a high value, meaning that the leasing company believes that it can get more than most people think it can for the sale of a vehicle at a future date, the leasing company can be more aggressive on the lease rates and terms (the payment offered to the consumer). For example, a new 2006 Chrysler Pacifica has an initial sales price of $25,000 and a first leasing company sets the residual value at $12,500 at the end of a thirty six month lease. If a competing second leasing company sets the residual value of the 2006 Chrysler Pacifica at $13,500 at the end of a thirty six month lease, the second leasing company will be able to offer lower lease payments and obtain substantially more business that the first leasing company, assuming that the effective interest rates offered by both leasing companies are the same. In this example, both companies must wait until the end of the lease to determine the profitability of the lease. If the actual value of the 2006 Chrysler Pacifica at the end of a thirty six month lease is $13,000, the first leasing company will not experience any loss. On the otherhand, the second leasing company will have a residual value loss of $500.

While it is true that the fist leasing company did not experience a loss on the residual value of the 2006 Chrysler Pacifica at the end of the thirty-six month lease, it did not benefit from the higher residual value either. Because most vehicle leases are closed end (the vehicle lessee has the option to purchase the vehicle at the end of the lease for the specified residual value), finance companies cannot take advantage of higher residual values at the end of the lease, unless the lessee returns the vehicle. In most situations, if the vehicle is worth more than the residual value at the end of a lease, the lessee will most likely purchase it at the residual value. They could then keep the vehicle or sell it on the open market. Here the lessee could purchase 2006 Pacifica and then resell it for a $500 profit. In this environment, leasing companies encounter considerable risk with respect to residual values on lease vehicles and have no way of capturing benefits when the residual values are higher than projected. Futures contracts will also enable more flexible pricing for the consumer in the leasing contract because consumer pricing will vary based on the current days trading price for the contract. There is a need for a system and method of protecting leasing companies against market risks associated with vehicle residual values.

One such method of trying to reduce such market risks is disclosed in U.S. Pat. No. 6,622,129 a method of creating an index of residual values for leased assets such as vehicles, transferring residual value risk, and creating lease securitizations, such as futures, options, and insurance products in consideration of the index of residual value. The problem with U.S. Pat. No. 6,622,129 is the disclosed method of calculating the residual value index that is used to create and price futures and options. U.S. Pat. No. 6,622,129 discloses the creation of a master index residual value index and sub residual value indexes. The master residual value index would include all cars and light trucks sold in the U.S. in a particular model year. Similar indexes can be created for other countries or groups of countries. The master residual value index can also have related indexes and sub indexes. Examples include: pickup trucks, sedans, Ford automobiles, eight cylinder automobiles, blue cars, red cars, convertibles, luxury cars, cars with initial prices over $30,000, cars leased through Toyota Motor Credit, and cars sold in California. The problem with this method is that the residual value indexes and sub indexes disclosed in U.S. Pat. No. 6,622,129 do not generate index values that commodities vehicles. Most leasing companies have leases on specific vehicles in its portfolio, so indexes upon which all vehicles are based do not accurately reflect market value in a manner that will allow for creation of a futures commodity. By including all vehicles, some of which drop in value more than others, the residual value index disclosed in U.S. Pat. No. 6,622,129 is not one upon which leasing companies are willing to rely in hedging risk. For example, a leasing company that leases a Ford F150 2WD V6 will find it insufficient to utilize an index value based on all Ford Truck if the value of that specific vehicle fluctuates relative to warranty or other issues that are specifically related to that vehicle make and model. Because residual value is one of the variables that effects the lease rates and terms a leasing company may offer consumers, a leasing company is looking to put itself in a position where it can set its lease rates and terms aggressively without taking on too much risk associated with those rates and terms. Accordingly, there is a need for a mechanism to reduce such risks while simultaneously allowing the leasing company to set its lease rates and terms aggressively. There is a need for a method and allows leasing companies to hedge risk based upon a residual index value that accurately reflects actual market value for a specific vehicle at the time of settlement of a futures contract.

### SUMMARY OF THE INVENTION

The present invention comprises a method of generating a market settlement value for use with settlement of vehicle futures contracts traded on a commodities exchange. The method comprises a plurality of steps. A first step comprising the importing of vehicle data files from a data source into data storage wherein each of the data files includes data representative of information describing the details of an associated vehicle. A second step comprises the filtering of vehicle data files by removing vehicle data files that fail to satisfy predetermined vehicle condition standards and storing the remaining filtered vehicle data files in a data storage medium. A third step comprises generating a market settlement value for an identified class of vehicles within the remaining filtered vehicle data files. Within the method for generating a market settlement value, the data representative of information describing the details of each vehicle includes the vehicle year, make, model, mileage, manufacturer VIN code and transaction price for the vehicle at its last sale. In some embodiments, the information describing each vehicle includes a damage estimate which may be included in the transaction price of the associated vehicle. The step of filtering the vehicle data files is accomplished by matching each manufacturer VIN code within each of the vehicle data files with manufacturer VIN codes identified within a title history database. For each manufacturer VIN code identified within each vehicle data file matched with manufacturer VIN codes in the title history database, the file associated with the matched manufacturer VIN code within the title history database is processed in order to determine if the file includes title information that indicates that the associated vehicle has problems with its title. If the respective title history data file indicates that the associated vehicle has problems with its title, the vehicle data file shall be removed from the imported vehicle data files. The step of generating a market settlement value is accomplished by grouping the remaining filtered data files into segments of vehicles wherein each of the vehicle segments is comprised of all vehicles that have a common digit pattern within its associated manufacturer VIN code. The market settlement value for a specific vehicle segment is generated by determining the average transaction price for vehicles within that vehicle segment. The above described method is implemented by a system comprised of a data repository that stores vehicle data files, a history filter operatively connected to the data repository and configured to filter the vehicle data files retrieved, a matching engine operatively connected to the history filter and a pricing engine operatively connected to the matching engine for accessing and processing transaction prices for a select group of vehicles to determine the market settlement value. The market settlement value is used as an index price to assess gains and losses associated with vehicle futures contracts.

### BRIEF DESCRIPTION OF THE DRAWINGS

FIG. 1 is a diagram illustrating an exemplary system for generating market settlement value for futures contracts;

FIG. 2 is a diagram illustrating a graphical user interface illustrating data fields that may be illustrated to a use of the system that purchases a futures contract;

FIG. 3 is a flow diagram illustrating operational flow in generating market settlement value for futures contracts, according to one embodiment;

FIG. 4 is a flow diagram illustrating operational flow in generating market settlement value for futures contracts, according to one embodiment;

FIG. 5 is a flow diagram illustrating operational flow in generating market settlement value for futures contracts, according to one embodiment;

FIG. 6 is a flow diagram illustrating operational flow in generating market settlement value for futures contracts, according to one embodiment;

FIG. 7 is a flow diagram illustrating operational flow in generating market settlement value for futures contracts, according to one embodiment;

FIG. 8 is a flow diagram illustrating operational flow in generating market settlement value for futures contracts, according to one embodiment;

FIG. 9 is a flow diagram illustrating operational flow in generating market settlement value for futures contracts, according to one embodiment; and

FIG. 10 is a flow diagram illustrating operational flow of the bidding offer and acceptance process between buyers and sellers.

### DETAILED DESCRIPTION OF THE PREFERRED EMBODIMENT

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (a) as a sequence of computer implemented steps running on a computing system and/or (b) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

The present invention is a system and method of generating a market settlement value for use with settlement of vehicle futures contracts traded on a commodities exchange. A futures contract is a standardized contract to buy or sell a specified quantity or grade of commodity at a specified price on a fixed future date. Unlike forward contracts, future contracts contain standardized terms and are traded on regulated exchanges.

In the commodities exchange market, natural hedgers of grains (farmers versus bakeries and cereal companies), by themselves, do not create an efficient market. Timing of demand and supply create imbalances. Wheat supply from farms comes only twice a year: June (Winter wheat) and October (Summer wheat). Demand, however, is relatively constant year around. Efficient markets require another participant in the market: participants willing to manage the seasonal supply/demand imbalances by taking on price risk. With no natural risk positions, this participant is not a hedger, but a speculator. These professional risk takers/managers are essential to an efficient market. Arbitragers take controlled price risk and are important to the success of any futures contract as they provide liquidity to the market.

Compared to agriculture's century-long experience with futures exchanges, transportation is a relative newcomer. Price volatility during 1999 and 2003 caused billions of dollars in losses for the automobile leasing industry and a 48% decline in lease originations. Automobile futures contracts can be referred to as a forward contract,—A contract to buy or sell an automobile for a fixed price at a specific (delivery) date sometime in the future.

The terms of automobile futures contracts are fixed and are not subject to negotiations. A futures contract has fixed volumes. A user of a future's contract must use multiple contracts to attain desired higher volume levels. For each futures contract, the quantity is also defined, along with the place and timing of delivery. The price of a futures contract is unspecified and determined daily during trading.

A futures contract is effectively a fixed-price contract. Accordingly, it has risk of loss associated with it as a result of counter party default. If prices decline and the buyer fails to perform, the seller loses the value of the contract. Likewise, if prices rise and the seller fails to perform, the buyer loses the value of the contract. To protect the exchange and its members from credit risk, the exchange requires each buyer and seller to post margin at the time of trade. Margin is a kind of security deposit of cash or government securities that protects the exchange against default. Margin requirements can vary, and futures brokers may impose higher margins than required by the exchange. The exchange will vary original margin requirements based on market volatility and unusual market conditions.

In addition to original margin, the exchange also requires additional margin adjustments that reflect price movements. These variation margin requirements are imposed daily. Losses, which are determined relative to a prior day settlement price, require payment into the margin account; gains result in payment from the exchange. These daily margin calls keep the collateral amount in the margin accounts in line with the credit exposures. Margin account activity is the immediate measure of performance of the futures positions measured in cash flow. Since each movement in the underlying commodity price results in a change in the variation margin and since price movements are not known ahead of time, using futures will result in unpredictable cash flows.

Technically, a futures contract is a physical supply agreement requiring delivery of the commodity. However, in practice, futures are used as purely financial instruments to manage price risk. Less than 1% of futures contracts traded in energy go to physical delivery. Almost all open positions are closed (i.e., contract buyers sell back the contracts, sellers buy back the contracts) prior to contract expiration. This is necessary since trading volumes in crude oil and natural gas far exceed the capacity at the delivery point such as Henry Hub and Cushing.

The ability to take physicals under a futures contract remains an important feature, even though few participants utilize that characteristic. The possibility of physical delivery imposes an arbitrage discipline on futures prices that forces convergence for futures prices with physical market prices. This convergence is essential if the futures contract is to perform as a price risk hedge tool. If futures prices are higher than physical prices, producers seeking to sell production will elect to sell futures. This will drive down futures prices while the shift in supply in the physical market will raise physical prices until there is convergence. Lower futures prices would trigger convergence beginning with the buyer.

In the vehicles futures market, there are four important factors, the ask (offer) price, bid price, transaction price and vehicle market settlement values. The asking price is a stated indication of a willingness to sell a specific quantity of a commodity at a stated price. The bid price is an indication of a willingness to buy a specific quantity of a commodity at a stated price. The transaction price is the current market price that a futures contract for a commodity is trading at. The market settlement value is the market value used by the commodities exchange to determine whether the futures contract price results in a loss or gain at the time of contract expiration.

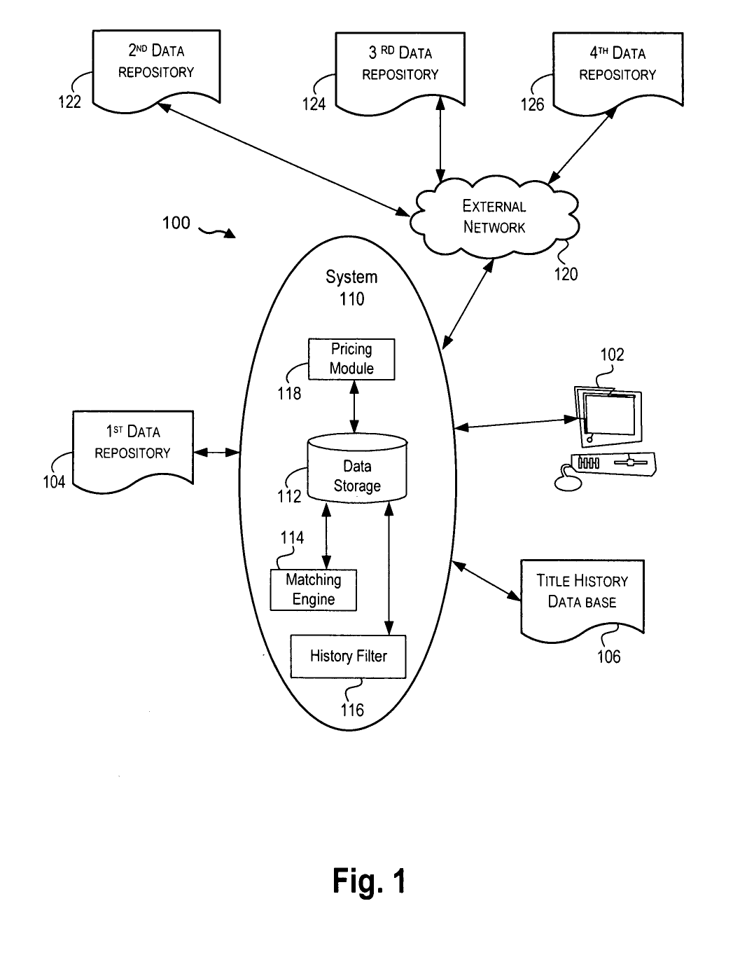

The method of generating a market settlement value for vehicle futures contracts traded on a commodities exchange is implemented by the system 100 illustrated in FIG. 1. The system 110 is comprised of data storage 112, a matching engine module 114, a history filter module 116 and a pricing module 118. The system 110 is accessed by a user via a networked computer 102. In performing the method of generating a market settlement values, the system 110 imports vehicle data files from a first data repository 104 into data storage 112. The vehicle data files imported from the first data repository 104 includes data representative of information describing actual individual vehicles, including data representative of a vehicles manufacturer VIN code, year of vehicle manufacture, make of the vehicle, model of the vehicle, mileage of the vehicle, transaction price of the vehicle, and in some data repositories such as second data repository 122, third data repository 124, or fourth data repository 126, data representative of damage to the vehicle. Data representative of damage to the vehicle includes actual images of the vehicle along with physical description of the vehicle condition observed by an inspector. As illustrated in FIG. 1, it is contemplated that a data repository such as first data repository 104 may be connected to system 110 via a local area network connection and second, third and fourth data repositories 122, 124 and 126 may be accessed by the system 110 via WAN or internet connection 120.

Following the importing of vehicle data files from a data repository, the vehicle data files are stored in data storage 112 and then processed by the history filter module 116, which performs the function of filtering each vehicle data file stored within data storage in order to determine the vehicle data files that do not satisfy pre-determined vehicle conditions. First, the history filter matches the manufacturer VIN codes of vehicle data files stored with manufacturer VIN codes of vehicle title files stored within the title history database 106. For each manufacturer VIN code of vehicle data files stored that is matched with manufacturer VIN codes of vehicle title files stored within the title history database 106, the history filter module 116 processes the matched vehicle title files to determine whether the associated vehicle has problems with its title. Upon determination that an associated vehicle has problems with its title and resulting from a failure to meet an excepted standard level, the vehicle data file is removed from the imported vehicle data files stored within the system 110. Data representative of information within the title history database 106 that may indicate that an associated vehicle has a problem with its title includes information representing that a vehicle was classified as a total loss, information representing that a vehicle has a scarred title, and information representing that a vehicle has excessive damage.

Next, the market settlement value is generated by grouping the filtered data files into segments wherein each vehicle segment is comprised of all vehicles that have an identical digit pattern within a manufacturer VIN code. In the preferred embodiment, the system 110, via matching engine module 114, segments vehicle data files by grouping all files having the same first 12 digits within the manufacturer's VIN code. It is to be understood, that vehicle segmenting may be generated by grouping vehicle data files based on an alternative set of identical digits within the 16 digit manufacturer VIN code, for example, the first seven digits. The concept of segmenting via the matching engine module 114 is to group vehicle data files based on similar characteristics that are driven by the manufacturer VIN code. Segments are further defined by the mileage characteristics of each vehicle. Within a segment, vehicles are grouped into a additional segments based on the total mileage on a respective vehicle. Vehicles having total mileage of less than 10,000 miles per year are in a first group, vehicles having total mileage of less than 12,500 per year are in a second group, and vehicles having total mileage of less than 15,000 per year are in a third group. In addition to the segments and groups within each segment, vehicle data files may be grouped based on the date of the vehicle transaction. For example, the segments and groups within each segment may comprise only vehicles that were sold within the last 30 days of selected date. Alternatively, all vehicles that have commonality within the first twelve digits of the manufacturer's VIN code may be segmented and groups within each segment may be formed based on mileage, and only those that have transactions within a period of time defined by the user are utilized in generation of the market settlement value. In defining the market settlement value, all transaction prices for each vehicle within a specific segment or group within a segment are added together and the average price of the vehicles within the segment or group define the market settlement value for use in settling futures contracts.

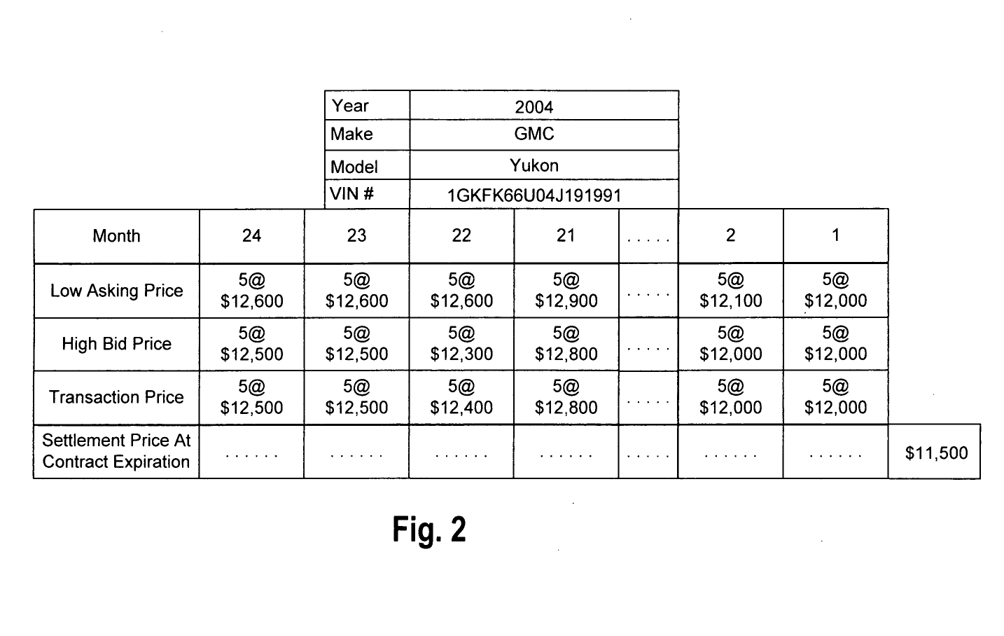

FIG. 2 illustrates the data point utilized in a vehicle's futures contract for a 2004 GMC Yukon having a vehicle identification number 1GKFK66U04J191991. In the commodities exchange environment, if an individual desires to purchase futures contracts that are trading on the exchange the information they would be reviewing would be similar to the information illustrated in FIG. 2. In the example illustrated in FIG. 2, the futures contract may have a twenty four to one month expiration term. In this example, for the twenty four month term, the seller is offering five contracts at $12,600.00. In the exchange process, FIG. 2 illustrates that the highest bidder purchases the contract for five 2004 GMC Yukons at $12,500.00. In month twenty four, 2004 GMC Yukons are trading at $12,500. All of the displayed prices and transactions in FIG. 2 are not occurring at the same time. They are occurring in their respective months. Month twenty four is two years out from the contract expiration. Month twenty three is one year and eleven months out from the contract expiration. The transaction price is what a futures contract for a 2004 GMC Yukon is trading for at any given point in time. For example, party A purchased the contract at $12,500.00. Upon the day the contract is set to expire in month 0, the 2004 GMC Yukon will have a market settlement value which is generated by the present invention. In this example the market settlement value is $11,500.00. So because the contract was purchased at $12,500.00 and the market settlement value is $11,500.00, the purchaser of the contract purchased it at $1,000.00 too high and therefore loses $1,000.00 for each of the five contracts and therefore loses $5,000.00 total on the futures contracts.

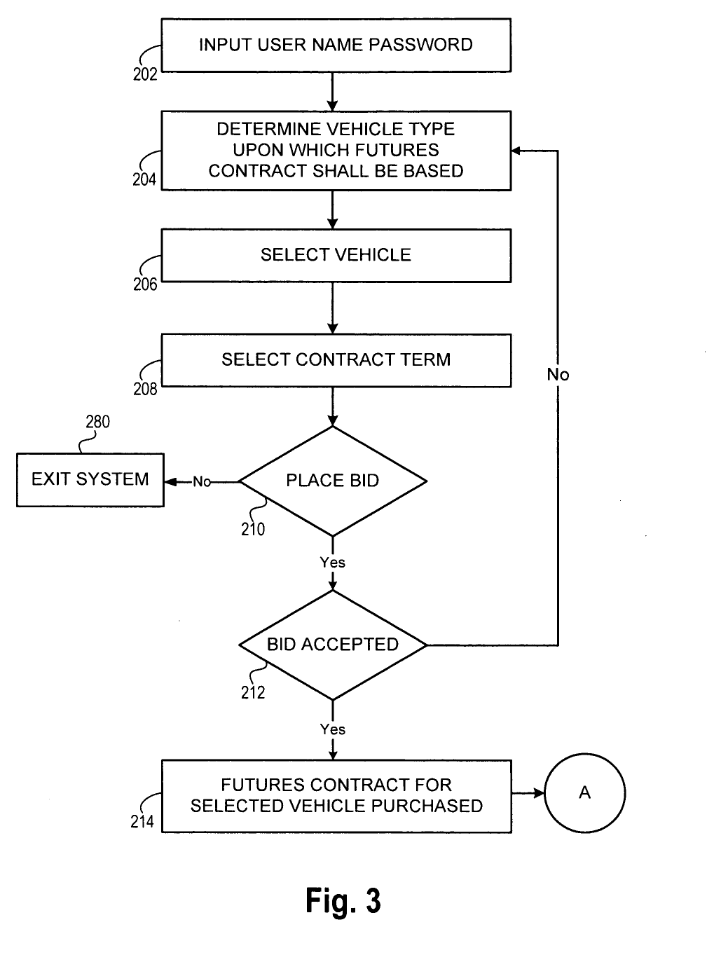

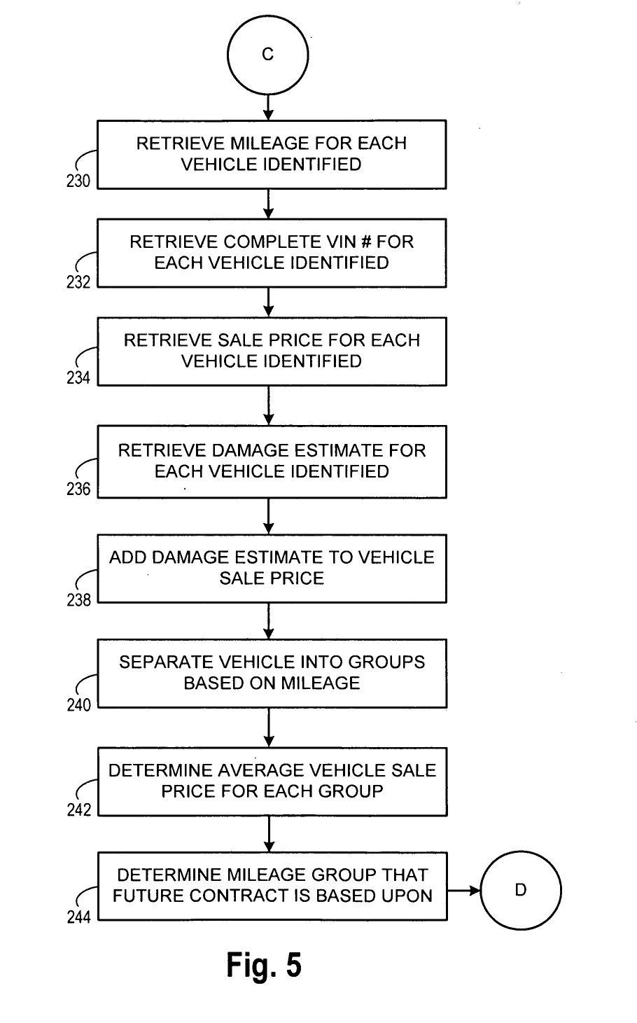

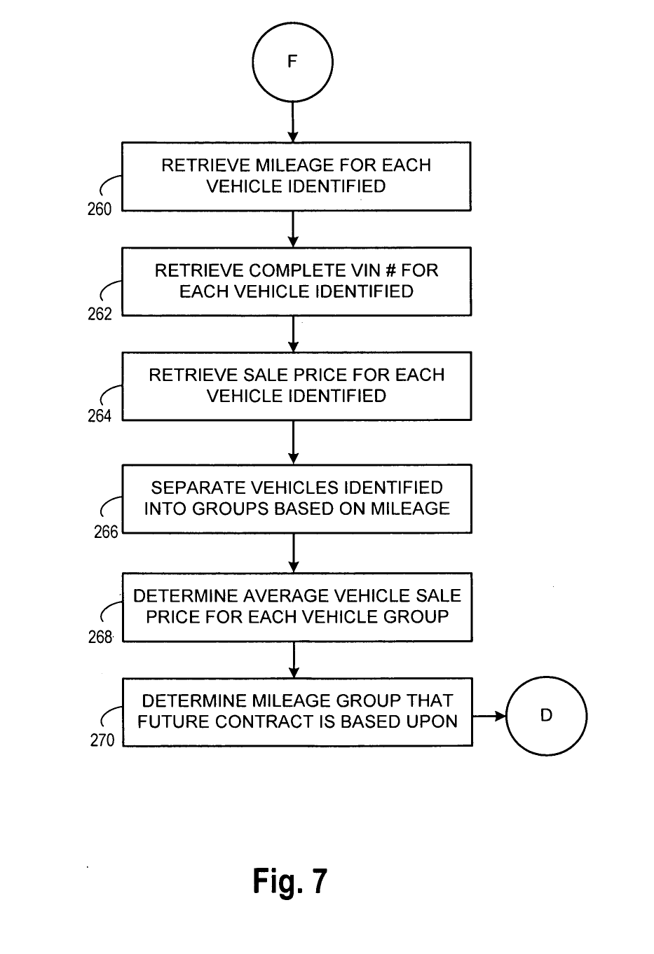

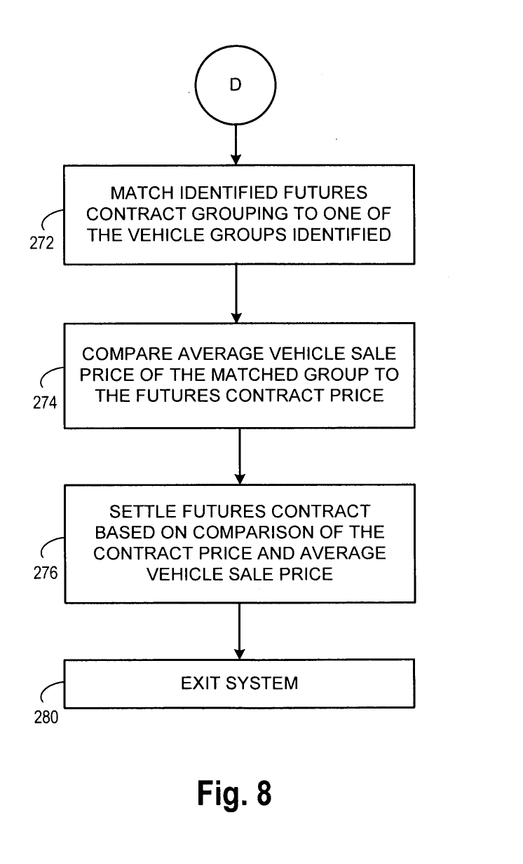

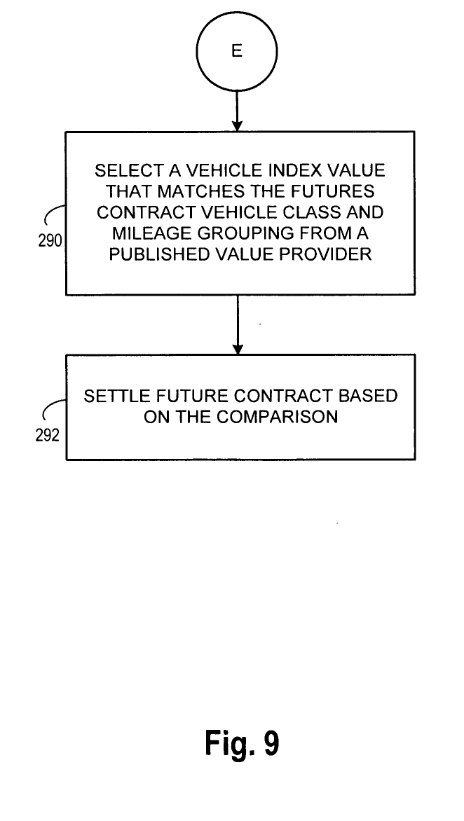

The process steps of generating a market settlement value for vehicle futures is illustrated in FIGS. 3-10, respectively. As illustrated in FIG. 3, first, the user of the system inputs a user name and password 202. Next, a determination is made of the vehicle type upon which futures contracts should be purchased 204. Upon a determination, the vehicle type is selected 206. Next, there is a selection of the contract term 208 (24 month, 12 month, 2 month, etc.). The user is queried as to whether they would like to place a bid 210. If the user does not desire to place a bid, they may exit the system 280. If the user desires to place a bid 212, and the bid is not accepted, the system returns the user back to a prompt at which the user must determine the vehicle type upon which vehicle futures contract should be purchased 204. If the bid is accepted 212, the system automatically purchases the futures contract for the selected vehicle in view of the margin account maintained by the purchaser. A margin account is a security deposit of cash or government securities that protects the exchange against default. It is an account in which a buyer or seller (trader) of futures contracts must maintained a predetermined level of security with their broker. This deposit is used to insure contract performance. This is not a down payment, but a reserve that guarantees that the trader will abide by the contract terms. If the market takes a turn for the worse for the trader, more margin money may be required. This is referred to as a margin call. If the trader fails to meet the margin call, the trader's position in the market may be ended. Likewise, if the market makes a positive move, the trader may take out money from the account. Margin requirements can vary and future brokers may impose higher margins than required by the exchange. The exchange will vary original margin requirements based on market volatility and usual market conditions.

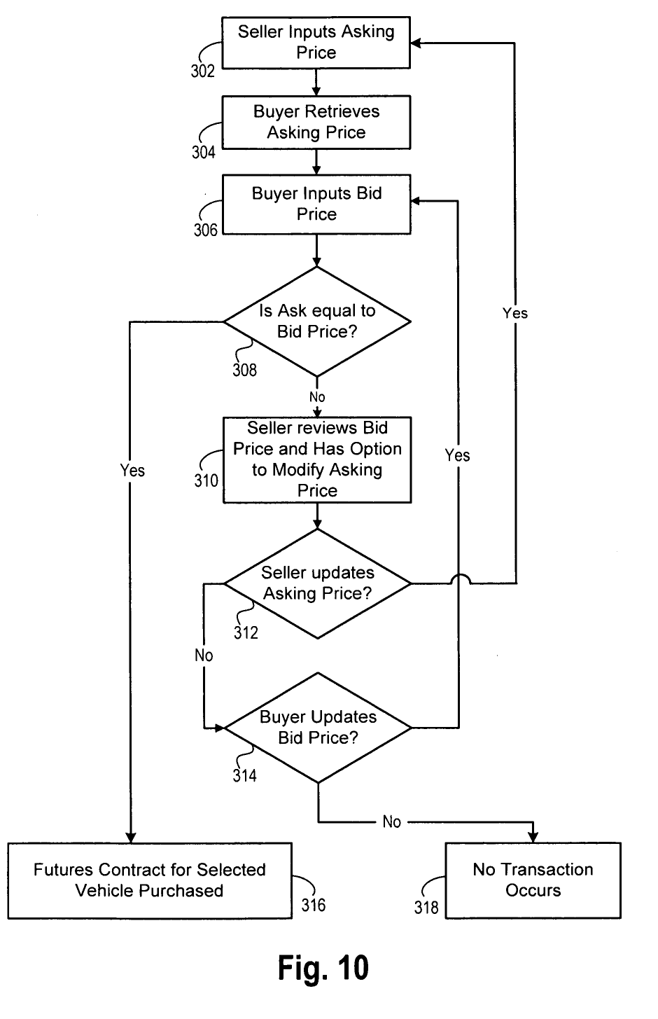

The process of the buying and selling futures contracts are illustrated in greater detail in FIG. 10. First, the seller inputs an asking price for a futures contract 302. Next, the buyer, upon accessing the system retrieves the asking price 304. Following review of the seller's futures contract asking price, the buyer inputs a bid price 306. The system compares the seller's ask price to the buyer's bid price to determine if they are equal 308. If the ask price is equal to the bid price, the futures contract upon which sought bids and the buyer placed a bid is automatically accepted and a contract purchase is executed 316. When the system compares the seller's ask price to the buyer's bid price to determine if they are equal 308. If the ask price is not equal to the bid price, the seller is afforded the option of reviewing the bid price offered and provided with an option to modify the asking price 310. Upon the seller updating the asking price 312, the buyer, who would instantaneously be able to retrieve the seller's new asking price 304, would be able to input a new bid price 306. The system compares the seller's ask price to the buyer's bid price to determine if they are equal 308. If the ask price is equal to the bid price, the futures contract upon which sought bids and the buyer placed a bid is automatically accepted and a contract purchase is executed 316.

When the system compares the seller's ask price to the buyer's bid price to determine if they are equal 308. If the ask price is not equal to the bid price, and the seller does not avail itself of the option 310 to modify the asking price 312, they buyer is afforded the option of updating the bid price 314. If the buyer updates the bid price 306, the system compares the seller's ask price to the buyer's bid price to determine if they are equal 308. If the ask price is equal to the bid price, the futures contract upon which sought bids and the buyer placed a bid is automatically accepted and a contract purchase is executed 316. If the buyer does not update the bid price 314, no transaction occurs 318.

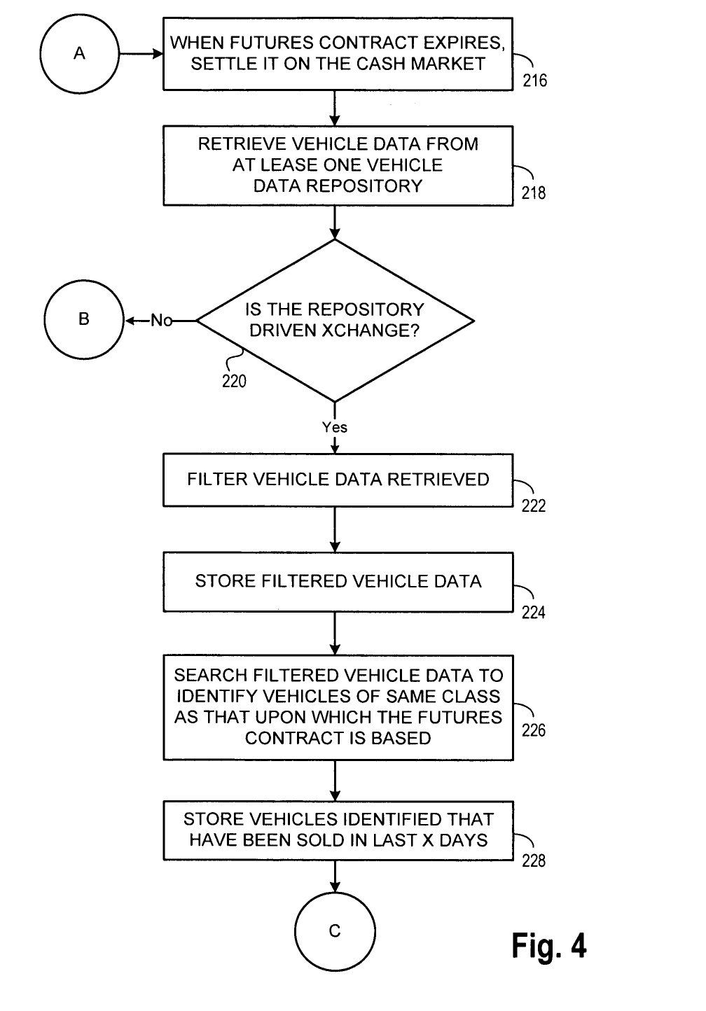

Referring to FIG. 4, when the vehicle futures contract expires, it is settled on the cash market 216. The system determines a market settlement value by retrieving vehicle data from at least one vehicle data repository 218. If the vehicle data repository is the driven exchange data repository 220, the vehicle data files are filtered 222, stored 224, and then searched to identify vehicles of the same class as that upon which the futures contract is based 226. The vehicles are then stored based on whether the vehicles were involved in a transaction within the last X days 228. The number of days may be 30, 45, or 60 days. It is contemplated that the program is written to allow the exchange to change the days within which the vehicle transaction occurs in an effort to allow flexibility within the data utilized to generate the market settlement value.

Next, of the vehicle data files stored, the system retrieves the mileage 230, VIN number 232, sale price 234 and damage estimate 236. Next, for each vehicle stored, the sale price and damage estimate are added 238. The vehicles are then separated into groups based on mileage 240, the mileage groups defining whether the vehicles are considered to be clean, average, or rough. Within each group of vehicles, the system determines the average vehicle sale price for each group 242. The average vehicle sale price is the market settlement value. Next, the system determines the mileage group upon which the futures contract was based 244. Next, the identified futures contract is matched to one of the vehicle groups identified 272. The system then compares the market settlement value of the matched group to the futures contract price 274. The futures contract is settled based on a comparison of the contract price and a market settlement value 276.

At step 220 illustrated on FIG. 4, if the repository is not the driven exchange repository, the system then queries whether the repository is the auction net repository 250. If the repository is the auction net repository, the system filters vehicle data files retrieved 252, stores the filtered vehicle data files retrieved 254, and searches the filtered vehicle data files to identify vehicles of the same class as that upon which the futures contract is based 256. Next, the system stores vehicles identified that have been sold in the last X number of days 258. Next, the system retrieves mileage for each vehicle identified 260, a complete manufacturer VIN code for each vehicle identified 262, the sale price for each vehicle identified 264 and separates the vehicles identified into groups based on mileage 266. The system then determines the average vehicle sale price for each vehicle group 268. Next, the system determines the mileage group that the futures contract is based upon (clean, average, or rough) 270. Next, the identified futures contract is matched to one of the vehicle groups identified 272. The system then compares the market settlement value of the matched group to the futures contract price 274. The futures contract is settled based on a comparison of the contract price and the a market settlement value 276.

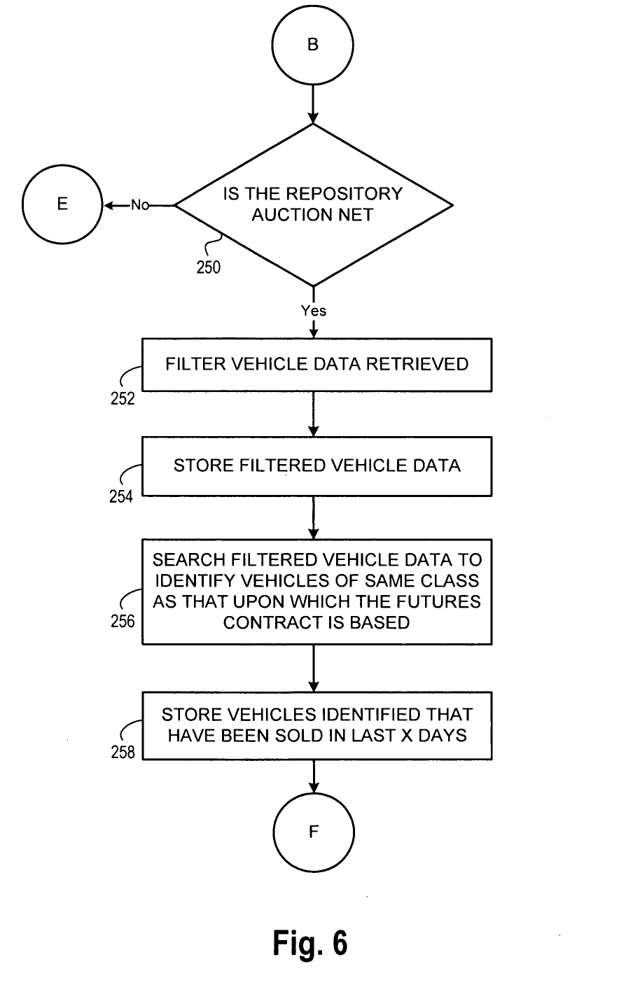

At step 250 illustrated in FIG. 6, if the data repository is not auction net, the system selects a vehicle index value that matches the futures contract vehicle class and mileage grouping from a published value provider 290 and then settles the future contract based upon that comparison 292. Published providers shall include any provider of used car values, such as Black Book, NADA Trade-In, Kelley Blue Book.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

We claim:

1. A method of generating a market settlement value for vehicle futures contracts traded on a commodities exchange, the method comprising the following steps:
importing vehicle data files from a data source into data storage, wherein each said vehicle data file includes information describing each vehicle;
filtering said vehicle data files by removing vehicle data files failing to satisfy predetermined vehicle condition standards and storing said remaining filtered vehicle data files;
generating a market settlement value for an identified class of vehicles within said remaining filtered vehicle data files.

2. The method of claim 1 wherein said information describing each vehicle includes the vehicle year, make, model, mileage, vehicle identification number and transaction price.

3. The method of claim 2 wherein said information describing each vehicle further includes a damage estimate, said damage estimate being included within said market settlement value.

4. The method of claim 1 wherein said filtering step comprises:
matching each vehicle identification number within each of said vehicle data files with vehicle identification numbers within a title history database;
for each vehicle identification number matched, processing title information in order to determine whether the associated vehicle has problems with its title; and
removing from said imported vehicle data files each file for which a determination has been made that the associated vehicle has problems with its title.

5. The method of claim 4 wherein title information indicating that an associated vehicle has problems with its title includes information representing that a vehicle was classified as a total loss, information representing that a vehicle has a scarred title and information representing that a vehicle has excessive damages.

6. The method of claim 1 wherein the step of generating a market settlement value is comprised of performing the following steps:
grouping said filtered data files into segments of vehicles wherein each of said vehicle segments is comprised of all vehicles having the a common digit pattern within a manufacturer VIN code;
adding transaction prices for each vehicle transaction within each said vehicle segment, wherein each said vehicle transaction must have occurred within a predefined number of days of settlement; and
determining an average sales price for each said vehicle segment, wherein said average sales price equals said market settlement value.

7. The method of claim 6 wherein said common digit pattern within a manufacturer VIN code is the first twelve digits of a manufacturer VIN code.

8. The method of claim 6 wherein each said transaction price for which damages estimate information is available includes said damages information within the transaction price in order to more accurately reflect the true market value of a specific vehicle.

9. The method of claim 1 wherein said data source is driven exchange.

10. The method of claim 1 wherein said data source is auction net, physical auctions, wholesale dealers, and retail dealers.

11. The method of claim 1 wherein said data source is at least one of the following, NADA Trade In, Kelley Blue Book Trade In and Black Book.

12. A system for generating a market settlement value for vehicle futures contracts traded on a commodities exchange comprising:
a data repository for storing vehicle data files;
a history filter operatively connected to said data repository and configured to filter said vehicle data files retrieved from said data repository by removing vehicle data files failing to satisfy predetermined vehicle condition standards,
a matching engine operatively connected to said history filter and configured to access said remaining filtered vehicle data files and group said remaining filtered vehicle data files into segments, wherein each vehicle data file within each of said segments has a common digit pattern within a manufacture VIN code associated with each said remaining vehicle data file; and
a pricing engine operatively connected to said matching engine for accessing transaction prices associated with each vehicle within a segment and processing said transaction prices to determine the market settlement value.
